(19) United States
(12) Patent Application Publication
(10) Pub. No.: US 2015/0284023 A1
(43) Pub. Date: Oct. 8, 2015

(54) POWER-ASSISTED STEERING CONTROL METHOD ENSURING THE COMPUTERISED PROTECTION OF THE STEERING TIE-RODS

(71) Applicant: JTEKT EUROPE, Irigny (FR)

(72) Inventor: Guillaume Lengrais, Lyon (FR)

(21) Appl. No.: 14/439,559

(22) PCT Filed: Oct. 29, 2013
(86) PCT No.: PCT/FR2013/052585

§ 371 Date: Apr. 29, 2015

(30) Foreign Application Priority Data
Oct. 31, 2012 (FR) 12/60425

(51) Int. Cl. B62D 6/10; B62D 5/04

(52) U.S. Cl. CPC B62D 6/10; B62D 5/0463; B62D 5/0481

(57) ABSTRACT

The invention concerns a control method for a power-assisted steering module, said method comprising a step (a) of assessing the steering wheel torque which involves obtaining an indicator signal representative of the intensity of the steering wheel torque (Cᵥₒₗₐₙₜ) exerted by the driver on the steering wheel, a monitoring step (b) which involves comparing the indicator signal, representative of the intensity of the steering wheel torque (Cvolant), to a pre-defined alert threshold (C1), then, if said indicator signal becomes higher than or equal to said alert threshold (C1), a step (c) of reducing the assistance which involves reducing the intensity of the assistance torque (Cassist) provided by the assistance motor (12), such that the sum of the steering wheel torque (Cvolant) and the assistance torque (Cassist) remains lower than or equal to a pre-defined critical operating torque, in order to preserve the steering tie-rods from plastic deformation.

### TECHNICAL FIELD

The present invention relates to the general field of power-assisted steering devices intended for vehicles of all kinds.

### BACKGROUND

Conventionally, the steering devices comprise a steering wheel which enables the driver to act on a steering column, which is in turn coupled, via a pinion, to a steering rack which is slidably mounted in a steering casing and the ends of which are connected to steering tie rods which engage on the steering knuckles carrying the steered wheels of the vehicle.

In general, such steering devices are also provided with an assist module comprising an assist motor, for example an electric motor, designed to transmit, for example via a worm and worm-wheel reducer, a torque for assisting the pinion.

One of the difficulties of making known steering devices stems from the configuration and sizing of the steering tie rods, which have to meet, in practice, two contradictory criteria.

Indeed, said steering tie rods should first present a resistance to plastic deformation, and more particularly to buckling, which is sufficient to ensure, without damage, all common operations, and in particular the clearance operations allowing to extract the vehicle from a parking situation where it is hampered by an obstacle or from a stuck situation.

However, these same steering tie rods should also remain sensitive enough to buckling so as to serve, in the event of a collision, as fusibility elements on which the deformation concentrates, and this in order to preserve the other members of the kinematic chain of the steering device during an accident.

### BRIEF SUMMARY

Consequently, the invention proposes a new solution allowing to meet these contradictory requirements.

For example, a control method for a steering assist module is provided, said assist module including at least one assist motor designed to provide an assist torque intended to be added to a steering wheel torque which is exerted by the driver on the steering wheel, said method comprising a step (a) of assessing the steering wheel torque during which is collected an indicative signal, representative of the intensity of the steering wheel torque exerted by the driver on the steering wheel, said method being characterized in that it comprises a monitoring step (b) during which the indicative signal, representative of the intensity of the steering wheel torque, is compared to a predetermined warning threshold, then, if said indicative signal becomes higher than or equal to said warning threshold, an assist reduction step (c) during which the intensity of the assist torque provided by the assist motor is reduced, so that the sum of the steering wheel torque and the assist torque remains lower than or equal to a predetermined critical operating torque.

A steering assist module is further provided comprising a calculator programmed to implement a control method according to the invention, as well as by means of a motor vehicle equipped with such an assist module.

Also, the invention provides a data carrier readable by a computer and comprising code elements of a computer program designed to implement a method for controlling a steering module according to the invention when said program is executed by a computer.

Advantageously, the invention hence proposes, in a general manner, to create a form of safety interaction between, on the one hand the electronic control module which controls the power-assisted steering device, and on the other hand the mechanical effector members of said steering device, which interaction allows making the mechanical sizing criterion of said members more flexible in view of their resistance to deformation.

Indeed, the invention allows to dose, in the predictable driving situations, and more particularly in some parking situations, the assist torque, whose set point is set by said assist module, in order that the total operating torque, which is applied to the mechanical members of the kinematic chain of the steering device, and which results from the sum, on the one hand, of the steering wheel torque, imparted to the steering wheel by the muscular force of the driver, and on the other hand, of the assist torque, artificially created by the assist motor (for example mechanical or hydraulic) and which reinforces said steering wheel torque, does not exceed, under no circumstances, a critical value which would cause the irreversible plastic deformation of either one of said members.

More particularly, the invention allows compensating, where necessary, an excess of the manual steering wheel torque by a reduction of the artificial assist torque, so as to restrict the total operating torque in order to permanently maintain it below the limit mechanically admissible by the steering members.

Consequently, the mechanical members constitutive of the steering device, and more particularly the steering tie rods, may be sized, and even undersized, without risk, according to the fusibility criterion, that is to say so as to be easily and effectively deformed in the event of an accident in order to preserve the rest of the kinematic chain, while the onboard electronic control module is now in charge of preventing, in normal driving situations, the occurrence of an effort exceeding the resistance capabilities of such a sizing.

In other words, thanks to the invention, it is no longer necessary to base each of these functions, in terms of resistance function on the one hand, and of fusibility function on the other hand, only on the sizing of the steering members.

Henceforth, it is in fact possible to prefer the addition to the assist module of a function of analysis and dynamic adaptation of the steering system, which allows adapting, in an scalable manner, depending on the circumstances, the way the steering members are mechanically loaded, so that said members are not exposed, during a normal and predictable operation of the steering, to a situation which would risk to cause their plastic deformation.

Thus, the invention allows somehow replacing a purely mechanical type passive protection against deformation with a smart type active protection against deformation.

In practice, this advantageously would be like making the sizing criterion of strictly mechanical resistance of the tie rods more tolerant.

Advantageously, the invention therefore allows reconciling, with high reliability, the different design criteria of the steering tie rods, by separating more clearly the different operating modes of said tie rods, whether in terms of resistance or fusibility, which operating modes thus may be optimized without interfering with each other.

Furthermore, the invention makes it possible to lighten the tie rods, and consequently to make significant saving of material and onboard mass.

More generally, the involvement of the electronic portion of the assist module to protect the mechanical members of the steering device allows for a simple and inexpensive implementation of the invention, capable of reducing the overall dimension and the overall weight of said steering device.

### BRIEF DESCRIPTION OF THE DRAWINGS

Other characteristics and advantages of the invention will appear in more detail upon reading the following description, with reference to the appended drawings, provided purely as illustration and without limitation, among which:

FIG. 1 illustrates, in a schematic perspective view, an example of a power-assisted steering device which may be controlled by a method according to the invention.

FIG. 2 illustrates, according to a functional block diagram, an example of an assist law allowing the implementation of a method in accordance with the invention.

FIG. 3 illustrates, according to a functional block diagram, an example of a strategy for protecting the steering tie rods corresponding to the implementation of a method in accordance with the invention.

FIG. 4 illustrates, according to a timing diagram, an example of progress of a method in accordance with the invention.

### DETAILED DESCRIPTION

The present invention concerns, in a general manner, the power-assisted steering devices 1, intended for driving vehicles, and more particularly motor vehicles, such as wheeled vehicles intended for the transport of persons and/or goods.

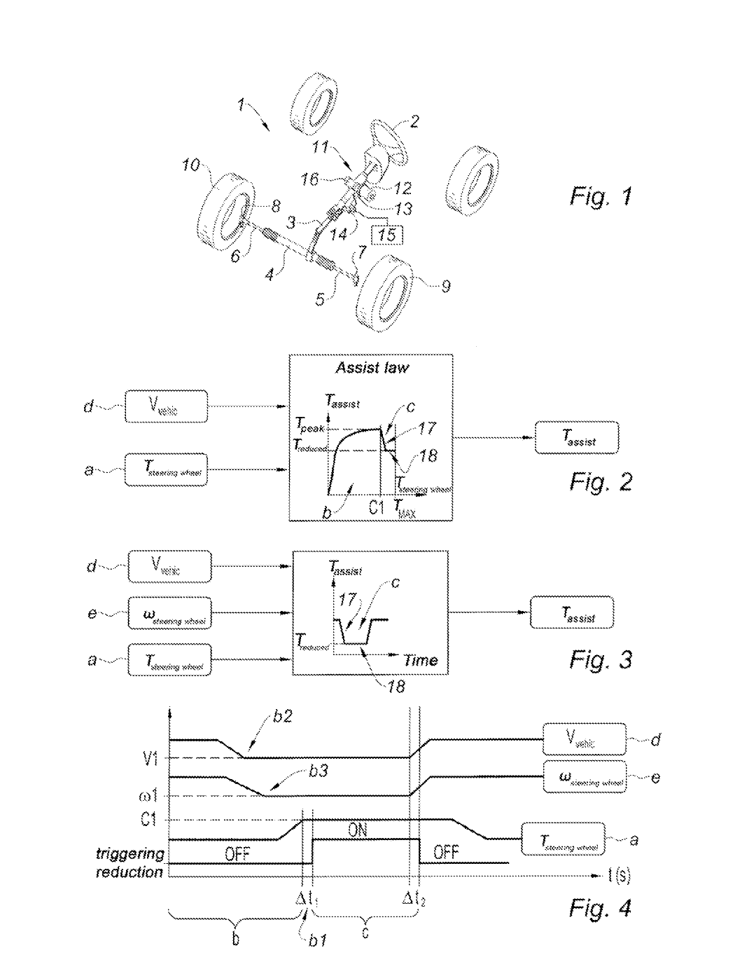

As is illustrated in FIG. 1, such steering devices 1 comprise a steering wheel 2 connected to a steering column 3, the end of which remote from the steering wheel 2 carries a steering pinion engaging a steering rack (not visible) mounted in a steering casing 4.

The two opposite ends of said rack are respectively connected, via left 5 and right 6 steering tie rods, each equipped, at their outer end, with a left 7 and right 8 steering ball joint, to the hub carriers (not represented) of the left 9 and right 10 steered wheels of the vehicle.

Advantageously, the steering 1 comprises, in order to assist the manual effort exerted by the driver of the vehicle on the steering wheel 2, a steering assist module 11, which includes at least one assist motor 12 designed to provide an assist torque intended to be added to the steering wheel torque T_{steering wheel} which is exerted by the driver on the steering wheel 2.

The assist motor 12 may for example be hydraulic, or preferably electric, advantageously with double direction of rotation.

The output shaft of said assist motor 12 will be coupled to the steering column 3, preferably via a reducer 13, for example of the worm and worm-wheel type, so as to be able to transmit an assist torque Tₐₛₛᵢₛₜ, whether motive or resistant, to said steering column 3.

The assist motor 12 is driven by an onboard electronic calculator 14, preferably connected to a CAN (Controller Area Network) network 15 of the vehicle, which allows said calculator to receive and process various signals coming from various sensors supervising various parameters of the behavior of the vehicle and its members.

Based on these information, the calculator 14 drives the assist motor 12, by imposing, at any time, appropriate set points, such as a supply intensity corresponding to the desired assist torque Tₐₛₛᵢₛₜ, in order to amplify or, on the contrary, compensate the effort applied by the driver on the steering wheel 2, according to predefined assist laws, programmed in a non-volatile memory of said calculator 14.

In this respect, the control method for a steering assist module, in accordance with the invention, comprises in particular a step (a) of assessing the steering wheel torque during which is collected an indicative signal representative of the intensity of the steering wheel torque T_{steering wheel} exerted by the driver on the steering wheel 2.

For this purpose, the calculator 14 may for example receive an indicative signal coming from a torque sensor 16 placed on the steering column 3 and thereby measuring the torque T_{steering wheel} exerted by the driver on the steering wheel 2. In particular, it is possible to use for this purpose a strain gauge associated to a torsion bar interposed between a section of the steering column 3 connected to the steering wheel and another section of the steering column connected to the pinion.

Of course, any type of indicative signal which is representative of the steering wheel torque T_{steering wheel} may be used, whether it comes from a direct measurement of the torque by a suitable sensor 16, or from an indirect assessment from other parameters, in particular related to the assist motor 12.

According to the invention, the control method comprises a monitoring step (b) during which the indicative signal, representative of the intensity of the steering wheel torque T_{steering wheel}, is compared to a predetermined warning threshold T1, then, if said indicative signal becomes higher than or equal to said warning threshold T1, an assist reduction step (c) during which the intensity of the assist torque Tₐₛₛᵢₛₜ provided by the assist motor 12 is reduced, so that the sum of the steering wheel torque T_{steering wheel} and assist torque Tₐₛₛᵢₛₜ remains lower than or equal to a predetermined critical operating torque T_{critical}.

By <<intensity of the torque >>, it is meant the absolute value of the concerned torque, measuring the quantity of the latter. Thus, within the meaning of the invention, a torque reduction, and in particular an assistance reduction, will be assimilated to a decrease of the absolute value of said torque, the magnitude of said torque being lowered toward zero.

In this respect, it is remarkable that the invention advantageously allows adapting, and more particularly reducing, an assist torque Tₐₛₛᵢₛₜ which has the same (algebraic) sign as the steering wheel torque T_{steering wheel}, and which keep, during the assist reduction, the same sign as the steering wheel torque T_{steering wheel}, and preferably, a non zero intensity.

In other words, the assist reduction advantageously takes place in a situation in which the assist operates in a mode of reinforcing (and not compensating) the steering wheel torque T_{steering wheel}, that is to say in which the assist torque Tₐₛₛᵢₛₜ and the steering wheel torque T_{steering wheel} act in the same (steering) direction on the steering column 3, cumulatively, by addition of their respective intensities.

Thus, the invention allows, while preferably keeping an amplification of the steering wheel torque T_{steering wheel} by the assist torque Tₐₛₛᵢₛₜ both before and during the assist reduction step (c), to reduce the magnitude of said amplification when said reduction step (c) is triggered.

Preferably, the critical operating torque T_{critical} is defined depending on the mechanical resistance of the mechanically weakest member of the steering device 1, for example of one of the steering tie rods 5, 6 (to which, for convenience, reference will be preferably made hereinafter).

More particularly, the critical operating torque T_{critical} may be chosen so that it corresponds to the quotient of the maximum admissible torque Tₘₐₓ_{_{—}}_{admissible} which is admissible by the steering device 1, that is to say the threshold torque beyond which would be caused the plastic buckling of the mechanically weakest member of said steering device 1 (in particular, the rack, the casing 4, and the tie rods 5, 6), divided by a safety factor k comprised between 1.15 and 1.35.

In other words, the choice will preferably be as follows:

T_{critical}=1/k*Tₘₐₓ_{_{—}}_{admissible},

with 1.15≦k≦1.35.

The maximum admissible torque Tₘₐₓ_{_{—}}_{admissible}, on which will depend the configuration and the sizing of the steering device 1 (and vice versa), may be for example specified by the specification sheet of the constructor, based in particular on the characteristics of the vehicle to be equipped and on the foreseeable use of said vehicle.

Thus, the maximum admissible torque Tₘₐₓ_{_{—}}_{admissible} may for example correspond substantially to the elastic limit R_{ec} of the tie rods 5, 6 under compression, or to the plastic deformation limit at 0.2% of said tie rods R_{p0.2}, that is to say Tₘₐₓ_{_{—}}_{admissible}=R_{ec}(tie rods) or Tₘₐₓ_{_{—}}admissible=R_{p0.2} (tie rods).

As a concrete example, the critical operating torque T_{critical}, which of course should be higher than the maximum predictable of the steering wheel torque T_{steering wheel}, may be chosen between 70 N.m and 85 N.m, and for example in the order of 80 N.m.

The maximum predictable steering wheel torque T_{steering wheel} may be, in turn, specified by the constructor, depending in particular on the configuration of the steering wheel 2 and of the maximum muscular force that may be expected to be developed by the driver.

As an indication, the maximum predictable steering wheel torque T_{steering wheel} may be chosen between 30 N.m and 50 N.m, and for example close to 45 N.m.

From these elements, it is possible to determine the admissible evolution range of the assist torque Tₐₛₛᵢₛₜ, so as to permanently maintain the level of loading the mechanical members of the steering kinematic chain in an operation field which does not damage said mechanical members, and more generally which does not damage the steering device 1: T_{steering wheel}+Tₐₛₛᵢₛₜ≦T_{critical}.

Advantageously, the method of the invention will be applied in particular, even exclusively, while the movable mechanical members of the steering are not in an end-of-stroke position in abutment against an internal stop of the steering device 1, and more particularly while the rack is not in an end-of-stroke abutment in the steering casing 4.

In other words, the method may advantageously be applied to a “free” steering phase, during which the steering device 1 (still) has some reserve of travel in the direction of the steering, and during which the resistance, and even the opposition, to the steering, which is felt against the operation of the steering wheel 2, and which tends to encourage the driver to increase the steering wheel torque, comes actually, and even exclusively, from the bearing of the steered wheels 9, 10 against an obstacle external to the steering device 1 and to the vehicle, and not from a blocking of the steering mechanism against an internal stop.

Typically, the method, and more particularly the assist reduction step (c), may intervene in a situation where the vehicle is laterally hampered by an obstacle, for example because it is parked against a sidewalk or stuck in a rut, in which situation the driver tries to use the concerned steered wheel(s) 9, 10 as lever(s) in order to push back the vehicle away from the obstacle, by forcing the azimuthal rotation of the wheel(s), the edge of which bears against said obstacle.

Advantageously, the intervention of the electronic control of the assist module 11 will therefore allow to adjust and dose in real time the assist torque Tₐₛₛᵢₛₜ, in order to, on the one hand, keep a functional amplification of the steering wheel torque T_{steering wheel}, and thus facilitate the operation (typically a clearance operation) sought by the driver while, on the other hand, restricting the contribution of the assist torque Tₐₛₛᵢₛₜ to the overall operating torque, in order to preserve the mechanical integrity of the steering members loaded by said overall operating torque.

By allowing to distinguish the different life situations of the vehicle, and by allocating dissociate operating modes thereto, the joint management, both mechanical and electronic, of the steering device 1 allows ensuring, with a high reliability, the fusibility of the tie rods in the event of an accident as well as the mechanical strength of said tie rods during operations, and in particular clearance operations, with no need for over-sizing said tie rods.

Hence, a significant lightening of said tie rods 5, 6, and more generally of the steering device 1, is made possible by the invention. The warning threshold T1 may, in turn, correspond for example to a chosen fraction of the maximum predictable steering wheel torque T_{steering wheel}, or to a fraction of the critical operating torque T_{critical}, or still further, as is illustrated in FIG. 2, to a fraction of the caliber Tₘₐₓ of the torque sensor 16, that is to say to a fraction of the detection ceiling value which corresponds to the high saturation value of said torque sensor.

As an indication, said caliber (high saturation value) Tₘₐₓ may for example be in the order of 10 N.m. In practice, the warning threshold T1 will preferably correspond, in turn, to an intensity of steering wheel torque T_{steering wheel} chosen between 6 N.m and 10 N.m, and preferably between 6 N.m and 7 N.m.

Moreover, the method according to the invention preferably comprises a step (d) of assessing the speed of the vehicle, during which the speed of advance V_{vehic} of the vehicle is assessed.

During the monitoring step (b), it is then possible to apply a speed non-exceeding criterion (b2), according to which there is set, as a condition for triggering the assist reduction step (c), the fact that the speed of advance V_{vehic} of the vehicle is lower than or equal to (in absolute value) a predetermined speed threshold V1, preferably substantially equal to zero (namely V_{vehic}≦0 m/s).

The speed of advance V_{vehic} here corresponds to the absolute value of the longitudinal displacement speed of the vehicle, in the forward direction or, optionally in the backward direction.

Advantageously, by setting an additional condition to the triggering of the assist reduction step (c), and more particularly a condition according to which the speed V_{vehic} of the vehicle should be substantially equal to zero, it is possible to identify the situations in which the vehicle is stationary, and thereby limit the implementation of said reduction step (c) to such situations.

In practice, it is thereby possible to limit the use of the method to a “park assisting”, the stationary state of the vehicle being detected by the non-exceeding of the speed threshold V1.

Preferably, the method may further comprise a step (e) of assessing the rotational speed of the steering wheel, during which is assessed the rotational speed ω_{steering wheel} of the steering wheel 2 that the driver confers to said steering wheel 2 by operating said steering wheel.

During the monitoring step (b), it is then possible to apply a steering wheel rotational speed non-exceeding criterion (b3), according to which there is set, as a condition for triggering the assist reduction step (c), the fact that the rotational speed ω_{steering wheel} of the steering wheel is lower than or equal to a predetermined rotational speed threshold ω₁, preferably in the order of 1 1 rpm to 2 2 rpm, and even substantially equal to zero.

If appropriate, it is also possible to use, for this purpose, in an equivalent manner, a measurement of the rotational speed of the assist motor 12, which is in principle representative of the rotational speed of the steering wheel 2, in consideration of the reduction ratio of the reducer 13. In such case, it is possible for example to set as a rotational speed non-exceeding criterion the fact that the rotational speed of the shaft of the assist motor 12 is lower than or equal to 16 rpm.

Advantageously, such a rotational speed non-exceeding condition, preferably cumulative with either one of the previous conditions, allows in particular detecting a slow steering situation, and even a situation of blockage of the azimuthal rotation of the wheels 9, 10, which situation corresponds to a forced clearance operation during which the driver seeks to use at least one of the steered wheels 9, 10 as lever(s).

According to a preferred possibility of implementation of the method, the monitoring step (b) and the assist reduction step (c) follow, as is illustrated in FIG. 2, an assist law which defines the assist torque Tₐₛₛᵢₛₜ (or, more particularly, the intensity set point applied to the assist motor 12 for obtaining said assist torque Tₐₛₛᵢₛₜ) as an increasing function, preferably concave, of the steering wheel torque T_{steering wheel} (or, more particularly, of the corresponding indicative signal) up to the warning threshold T1, and then as a decreasing function of said steering wheel torque T_{steering wheel} beyond said warning threshold T1.

The increasing portion of the assist law may be strictly monotonic, nonetheless, it may deflect, so that the ascending slope is steeper at the start than at approach of the warning threshold T1, toward which the curve may possibly tend in a substantially asymptotic manner.

The decreasing portion may make the assist torque Tₐₛₛᵢₛₜ fall from a maximum Tₚₑₐₖ, corresponding to the value taken by said assist torque Tₐₛₛᵢₛₜ at the time the steering wheel torque T_{steering wheel} reaches the warning threshold T1, down to a plateau 18 of value T_{reduced} strictly lower than Tₚₑₐₖ, but preferably non zero.

The assist torque Tₐₛₛᵢₛₜ may preferably be maintained at this reduced plateau T_{reduced} as long as the application conditions of the reduction step (c) are fulfilled, and in particular, as long as the steering wheel torque T_{steering wheel} exceeds the warning threshold T1.

Moreover, the triggering of the assist reduction step (c) may be performed according to different temporal criteria, for example when the indicative signal reaches or exceeds said warning threshold, or if the indicative signal remains above said warning threshold during a time period larger than a predetermined delay time duration.

Thus, according to a possible implementation of the method, and in particular in combination with any of the aforementioned triggering conditions, a temporizing criterion (b1) may be applied during the monitoring step (b), as is illustrated in particular in FIG. 4, according to which there is set, as a condition for triggering the assist reduction step (c), the maintaining of the indicative signal representative of the intensity of the steering wheel torque T_{steering wheel} at a level higher than or equal to the warning threshold T1 for a predetermined delay time duration Δt₁, preferably in the order of 1 s to 2 s.

In other words, several switch options may be considered for conditioning the switching the control in accordance with invention from a “normal” amplified operating mode, during which the assistance Tₐₛₛᵢₛₜ increases as the steering wheel torque T_{steering wheel} increases, to a restricted operating mode, during which the assist torque Tₐₛₛᵢₛₜ is reduced, and/or on the contrary, for conditioning the return from the restricted operating mode to the normal operating mode. According to a first option, the switch may be immediate and direct, and occur as soon as the warning threshold T1 crossing condition is achieved, or, if appropriate, as soon as different cumulative triggering conditions are simultaneously fulfilled, at a given time, said different cumulative triggering conditions possibly comprising, in addition to the condition relative to the crossing of the warning threshold T1, the condition regarding the speed V_{vehic} of the vehicle and/or the condition regarding the rotational speed ω_{steering wheel} of the steering wheel.

Similarly, the assist reduction may persist as long as the indicative signal remains equal to or above the warning threshold T1, or more generally, as long as all the cumulative triggering conditions remain fulfilled, the return to the normal operating mode being achieved as soon as the condition (or, if appropriate, at least one of the cumulative conditions) is no longer met, that is to say, in particular, as soon as the indicative signal decreases below the warning threshold T1.

According to a second option, the switch may intervene, in a deferred manner, through temporizing, so that the switch from the normal mode to the restricted mode will happen after the triggering condition(s), and in particular exceeding of the warning threshold T1 by the indicative signal, (and if appropriate, all of said triggering conditions) has(have) been maintained during at least a delay time duration Δt₁.

Conversely, the return to the normal may be performed, as is illustrated in particular in FIG. 4, when a delay time duration Δt₂ (equal to or different from the duration used for the switch to the restricted mode) has elapsed after any one of the conditions for maintaining the restricted mode is removed, for example if the vehicle has regained speed, or if the rotational speed ω_{steering wheel} of the steering wheel has exceeded again the predetermined threshold ω₁, and/or if the steering wheel torque T_{steering wheel} has decreased below the critical threshold T1.

According to a variant, which will be particularly suitable for the temporizing management, the indicative signal used for the comparison to the warning threshold (T1) and used for temporizing during the monitoring step (b), corresponds to the intensity of the electric current applied to the assist motor 12. Indeed, it is possible to provide for an assist law which deterministically associates, in normal operation, an assist torque Tₐₛₛᵢₛₜ (or, in an equivalent manner, an intensity set point applicable to the assist motor) to every non-zero value of the steering wheel torque T_{steering wheel}.

In particular, said law may ensure an increase of the assist torque as soon as a non-zero steering wheel torque is perceived, and “quickly” reach a maximum, so as to cap at a predetermined maximum value even before said steering wheel torque T_{steering wheel} reaches the upper detection limit Tₘₐₓ of the torque sensor 16, and for example as soon as the steering wheel torque T_{steering wheel} reaches its warning threshold T1.

In such case, if it has been observed, during the monitoring step (b), that the intensity of the electric current applied to the assist motor 12 reaches and remains at the maximum level predicted by the assist law for the delay time duration Δt₁, then this necessarily means that the steering wheel torque T_{steering wheel}, which is the antecedent of said intensity of the electric current in the function defining the assist law, has crossed the warning threshold T1 and is remaining, and even progressing, above said warning threshold T1, during this same time period.

In particular, upon a steering operation during which one of the wheels 9, 10 encounters the resistance of an obstacle, the maximum assistance may be reached chronologically “in phase advance”, while the effort exerted by the driver on the steering wheel is still increasing, and consequently, the maximum assistance may be reached before the effective maximum of steering wheel torque is reached.

A detection of the anticipated capping of the assist torque (and more particularly of the intensity of the current supplying the assist motor), and a delayed triggering of the assist reduction step (c), calculated from the instant of this capping, therefore allows to make the decrease of the assistance Tₐₛₛᵢₛₜ substantially coincide with the phase-shifted occurrence of the effective maximum of steering wheel torque T_{steering wheel}.

Thus, having the steering wheel torque T_{steering wheel} overshooting the warning threshold T1 can be somehow neutralized by means of concomitantly reducing the assist torque Tₐₛₛᵢₛₜ.

As indicated above, it is in fact possible to advantageously provide for an assist law which associates to every non-zero value of the steering wheel torque T_{steering wheel} an intensity set point applicable to the assist motor, said law capping at predetermined maximum value as soon as the steering wheel torque T_{steering wheel} reaches its warning threshold T1, and trigger the assist reduction step (c) if it is observed, during the monitoring step (b), that the intensity of the electric current applied to the assist motor 12 reaches the maximum level provided for by said assist law and remains at said maximum level for the delay time duration Δt₁. Preferably, during the assist reduction step (c), and regardless of the conditions of triggering of said assist reduction step (c), the supply set point of the assist motor, and more generally the assist torque Tₐₛₛᵢₛₜ, is decreased by at least 10%, preferably by at least 20%, by at least 30%, by at least 40%, and even by at least 50%, with respect to the set point value Tₚₑₐₖ (more generally, with respect to the assist torque value) which has been reached at the time the indicative signal has exceeded the warning threshold T1.

Of course, the magnitude (or the proportions) of the assist reduction will be chosen depending on the maximum predictable intensity of the steering wheel torque T_{steering wheel}, so as to be sufficient for inflecting the progression of the total operating torque, and more particularly so as to at least restrict said total operating torque, in order to maintain said total operating torque below its critical value T_{critical}, by compensating at least partially, and even totally, the predictable increase of the steering wheel torque T_{steering wheel} beyond the warning threshold T1.

Preferably, during the assist reduction step (c), the supply set point of the assist motor 12 is reduced progressively, according to a monotonic decreasing function of time and/or of the indicative signal representative of the steering wheel torque T_{steering wheel}.

Advantageously, the progressive nature of the reduction, and more generally the progressive nature of the transitions between the normal operating mode and the restricted operating mode, not only allows to spare the mechanical and electrical members of the steering device, by avoiding sudden set point variations, but also allows for good safety and good ergonomics to operation, by providing the driver with a faithful and intuitive feeling of the reactions of said steering device 1.

Preferably, for this purpose, the assist reduction will be performed according to a decreasing ramp 17.

Moreover, the assist reduction profile, whatever it is, and more particularly said decreasing ramp 17, may preferably lead to a plateau 18.

Said plateau 18 will advantageously correspond to a floor-value, preferably non-zero, at which the reduced assist value T_{reduced} is maintained as long as the reduction step (c) applies.

As previously indicated, said plateau 18 may be located, for example, at least 10%, at least 20%, at least 30%, at least 40%, and even at least 50% below the starting point T_{peak of} the reduction profile, and more particularly below the starting point of the ramp 17, which starting point Tₚₑₐₖ corresponds here to the maximum assist torque Tₐₛₛᵢₛₜ reached at the time when the reduction step (c) is triggered.

Particularly preferably, T_{reduced} will be substantially comprised between 40% and 60% of Tₚₑₐₖ, and preferably about 50% of the latter, the reduction performed on the assist torque Tₐₛₛᵢₛₜ in order to relieve the steering device thus being substantially by one half.

An example of a dynamic operation of a method in accordance with the invention will be briefly described herein with reference to FIG. 4.

Initially, the steering device 1 is controlled in a normal operating mode, according to one or several common law(s) for amplifying the movements of the steering wheel 2 or returning said steering wheel to center position. Hence, the command for triggering the assist reduction step (C) is inhibited, on <<OFF>>.

However, the calculator 14 executes (and repeats), substantially in real time, and preferably by sampling, the step (b) of monitoring the different parameters involved in the decision making to trigger the reduction step (c).

Suppose that the speed V_{vehic} of the moving vehicle is initially higher than the speed threshold V1. When the vehicle is being parked, said speed decreases, then it is reduced to zero, passing below said speed threshold V1. The first application condition of the reduction law having regard to the speed non-exceeding criterion (b2) is thereby fulfilled.

When leaving the parking, the blockage of either one of the steered wheels 9, 10 against an obstacle, for example against the edge of a sidewalk, at steering, stops and even blocks the rotation of the steering wheel 2, the rotational speed ω_{steering wheel} of which falls below the threshold ω₁. The second application condition of the reduction law having regard to the rotational speed non-exceeding criterion (b3) is thereby fulfilled.

While the driver increases his effort on the steering wheel 2, against the resistance opposed by the obstacle, the steering wheel torque T_{steering wheel} (and consequently, the corresponding indicative signal) increases until reaching and even exceeding the warning threshold T1.

It will be remarkable that this warning threshold crossing situation may in particular be reported, if appropriate, either by (preferably direct) measurement of the steering wheel torque and by comparison of this measurement to the warning threshold T1, or, in a substantially equivalent manner, by the fact that the intensity of the current applied to the assist motor 12 reaches its capped maximal value.

A third, and major, triggering condition of the reduction step (c) is then fulfilled.

When these cumulative conditions remain fulfilled, here during a time period longer than the delay time duration Δt₁, and more particularly when the intensity of the current applied to the assist motor 12 is maintained at its capped maximal value during at least said delay time duration Δt₁, while the driver is continuing his effort on the steering wheel 2 in order to clear the vehicle from the obstacle, the method triggers the assist reduction step (c) (<<ON>> signal in FIG. 4), so as to switch in the restricted operating mode.

As is illustrated in FIG. 3, the assist torque Tₐₛₛᵢₛₜ, artificially generated by the motor 12 is then reduced, down to its plateau 18, at which it is maintained as long as the reduction command (<<ON>>) persists.

The total operating load, to which the steering device 1 is subjected, is hence electronically limited in order to avoid any damage to said steering device.

Once the vehicle has been cleared and leaves its parking, as shown by the increase of its speed V_{vehic} and/or as shown by the increase of the rotational speed ω_{steering wheel} of the steering wheel 2, said steering wheel having regained its free-travel amplitude, then the risk of statically forcing the steering device 1 to the point of deforming the tie rods 5, 6 is in principle discarded.

Hence, it is possible to put an end, if appropriate after a switch-back delay time Δt₂, to the assist reduction step (c), in order to switch back to the normal control mode (switch-back to <<OFF>>).

Of course, the invention is in no way limited to either one of the above-mentioned variants, those skilled in the art being naturally capable of freely isolating or combining together any of the characteristics described in the foregoing.

In particular, it is possible to condition the triggering of the assist reduction step (c) by the sole crossing of the warning threshold T1 by the steering wheel torque (or by any equivalent parameter), or on the contrary by one or several other condition(s) related for example to the speed of the vehicle or to the rotational speed of the steering wheel.

Moreover, the invention concerns a steering assist module 11, as such, comprising a calculator 14 programmed to implement the control method according to any one of the variants of the invention.

Said calculator 14 may take any appropriate form, such as a microprocessor, an electronic circuit board, a computer, a programmable logic controller, and even a virtual computer module integrated in an on-board computer.

The invention also relates to a motor vehicle equipped with a steering assist module 11 according to the invention.

Finally, the invention also concerns any data carrier readable by a computer (in particular by the calculator 14) and comprising code elements of a computer program designed to implement a method for controlling a steering module according to the invention when said program is executed by a computer.

1. A control method for a steering assist module, said assist module including at least one assist motor designed to provide an assist torque (Tₐₛₛᵢₛₜ) intended to be added to a steering wheel torque (T_{steering wheel}) which is exerted by the driver on the steering wheel of a steering device, said method comprising a step of assessing the steering wheel torque during which is collected an indicative signal representative of the intensity of the steering wheel torque (T_{steering wheel}) exerted by the driver on the steering wheel, said method comprising a monitoring step during which the indicative signal, representative of the intensity of the steering wheel torque (T_{steering wheel}), is compared to a predetermined warning threshold, then, if said indicative signal becomes higher than or equal to said warning threshold, an assist reduction step during which the intensity of the assist torque (Tₐₛₛᵢₛₜ) provided by the assist motor is reduced, so that the sum of the steering wheel torque (T_{steering wheel}) and the assist torque (Tₐₛₛᵢₛₜ) remains lower than or equal to a predetermined critical operating torque (T_{critical}), wherein, during the monitoring step, a temporizing criterion is applied, according to which there is set, as a condition for triggering the assist reduction step, the maintaining of the indicative signal at a level higher than or equal to the warning threshold for a predetermined delay time duration (Δt₁), and in that the indicative signal, used for the comparison of the warning threshold and used for temporizing during the monitoring step, corresponds to the intensity of the electric current applied to the assist motor.

2. The method according to claim 1, wherein there is provided an assist law which associates to every non-zero value of steering wheel torque (T_{steering wheel}) a intensity set point applicable to the assist motor, said law capping at a predetermined maximum value as soon as the steering wheel torque (T_{steering wheel}) reaches the warning threshold, and in that the assist reduction step is triggered if, during the monitoring step, it has been observed that the intensity of the electric current applied to the assist motor has reached and remained at the maximum level provided by said assist law for the delay time duration (Δt₁).

3. The method according to claim 1, wherein the warning threshold corresponds to an intensity of steering wheel torque (T_{steering wheel}) chosen between 6 N.m and 10 N.m.

4. The method according to claim 1, wherein the monitoring step and the assist reduction step follow an assist law which defines the assist torque (Tₐₛₛᵢₛₜ) as an increasing function of the steering wheel torque (T_{steering wheel}) up to the warning threshold, and then as a decreasing function of said steering wheel torque (T_{steering wheel}) beyond said warning threshold.

5. The method according to claim 1, wherein the predetermined delay time duration (Δt₁) is in the order of 1 s to 2 s.

6. The method according to claim 1, wherein it comprises a step of assessing the speed of the vehicle, during which the speed of advance (V_{vehic}) of the vehicle is assessed, and in that, during the monitoring step, a speed non-exceeding criterion is applied, according to which there is set, as a condition for triggering the assist reduction step, the fact that the speed of advance (V_{vehic}) of the vehicle is lower than or equal to a predetermined speed threshold.

7. The method according to claim 1, wherein it comprises a step of assessing the rotational speed of the steering wheel, during which the rotational speed (ω_{steering wheel}) of the steering wheel is assessed, that the driver confers to said steering wheel by operating it, and in that, during the monitoring step, a steering wheel rotational speed non-exceeding criterion is applied, according to which there is set, as a condition for triggering the assist reduction step, the fact that the rotational speed (ω_{steering wheel}) of the steering wheel is lower than or equal to a predetermined rotational speed threshold (ω₁).

8. The method according to claim 1, wherein, during the assist reduction step the supply set point of the assist motor is decreased by at least 10% with respect to the assist setpoint value (Tₚₑₐₖ) which has been reached at the time the indicative signal has crossed the warning threshold.

9. The method according to claim 1, wherein, during the assist reduction step, the supply set point of the assist motor is progressively reduced, according to a monotonic decreasing function of time and/or of the indicative signal, according to a decreasing ramp leading to a plateau which may be located at least 10% below the starting point (Tₚₑₐₖ) of said ramp.

10. The method according to claim 1 wherein the critical operating torque (T_{critical}) is chosen so that it corresponds to the quotient of the maximum torque (Tₘₐₓ_{_{—}}_{admissible}) admissible by the steering device, beyond which would be caused the plastic buckling of the mechanically weakest member of said steering device, any of the steering tie rods, divided by a safety factor comprised between 1.15 and 1.35: T_{critical}=1/k*Tₘₐₓ_{_{—}}_{admissible}, with 1.15≦k≦1.35.

11. A steering assist module comprising a calculator programmed to implement the control method according to claim 1.

12. A motor vehicle comprising a steering assist module according to claim 11.

13. A data carrier readable by a computer and comprising code elements of a computer program designed to implement a method for controlling a steering module according to claim 1 when said program is executed by a computer.
